(19) United States
(12) Patent Application Publication
(10) Pub. No.: US 2025/0375997 A1
(43) Pub. Date: Dec. 11, 2025

(54) HEAT EXCHANGE DEVICE AND VEHICLE INCLUDING THE SAME

(71) Applicants: HYUNDAI MOTOR COMPANY, Seoul (KR); Kia Corporation, Seoul (KR)

(72) Inventor: Myung Hwan KIM, Hwaseong-si (KR)

(21) Appl. No.: 18/930,812

(22) Filed: Oct. 29, 2024

(30) Foreign Application Priority Data
Jun. 10, 2024 (KR) 10-2024-0075242

(51) Int. Cl. B60H 1/00

(52) U.S. Cl. CPC B60H 1/00328

(57) ABSTRACT

A heat exchange device includes a heat exchanger having a flow passage configured to carry a heat exchange fluid, an air guide that is disposed at a side of the heat exchanger and defines an interior space, the air guide having a first side in fluid communication with an outside of the air guide and a second side in fluid communication with the heat exchanger, and a rotator disposed at the first side of the air guide and configured to rotate about a rotation axis.

### CROSS-REFERENCE TO RELATED APPLICATION

This application claims the benefit of priority to Korean Patent Application No. 10-2024-0075242, filed in the Korean Intellectual Property Office, on Jun. 10, 2024, the entire contents of which are incorporated herein by reference.

### TECHNICAL FIELD

The present disclosure relates to a heat exchange device, and a vehicle including the same, and more particularly, to a heat exchange device that may be used in a vehicle, and a vehicle including the same.

### BACKGROUND

An electric vehicle drives wheels by using electric energy of a battery as a power source. In some cases, the electric vehicle may dissipate heat generated from the battery and a motor that drives the wheels. For instance, a cooling module may be mounted on an electric vehicle to recover heat from heat-generating components, including batteries and motors, and discharge it to an outside. In some cases, as the demand for the design aesthetics of vehicles increases, researches for improve the aesthetics of vehicles may be conducted.

In some cases, where a cooling module is mounted on a vehicle, a hole may be defined around the cooling module to introduce cooling air. For example, the hole may be defined in a front area of the vehicle, such as a bumper of the vehicle, to supply the air on a front side of the vehicle to the cooling module. The hold defined at the front side of the vehicle may deteriorate the aesthetics of the vehicle and an overall aerodynamic performance of the vehicle.

### SUMMARY

The present disclosure describes an improvement of the aesthetics and aerodynamic performance of a vehicle by allowing parts in the vehicle to be effectively cooled, where holes are eliminated from a front area of the vehicle.

According to one aspect of the subject matter described in this application, a heat exchange device includes a heat exchanger that defines a flow passage configured to carry a heat exchange fluid, an air guide that is disposed at a side of the heat exchanger and defines an interior space, the air guide having (i) a first side in fluid communication with an outside of the air guide and (ii) a second side in fluid communication with the heat exchanger, and a rotator disposed at the first side of the air guide and configured to rotate about a rotation axis.

Implementations according to this aspect can include one or more of the following features. For example, the air guide may further define an introduction space that connects the outside of the air guide to the interior space, the introduction space being defined at a lower area of the air guide. In some examples, at least a portion of the rotator is disposed in the introduction space or faces the introduction space in a forward/rearward direction of the heat exchange device. In some examples, at least a portion of the introduction space may be defined at a rear side of the rotator.

In some implementations, the interior space may be defined at an area of the air guide, where the area of the air guide faces the rotator in an upward/downward direction of the heat exchange device. In some examples, the air guide may have an area that faces the rotator in an upward/downward direction of the heat exchange device and is spaced apart from the interior space.

In some implementations, the air guide may include a first area, wherein at least a portion of the first area faces the rotator in an upward/downward direction of the heat exchange device, and a second area that is connected to a rear side of the first area and defines at least a portion of the interior space. The rotator and the second area of the air guide may be spaced apart from each other in a forward/rearward direction of the heat exchange device, where a lower end of the second area is located at a lower end of the first area. In some examples, the first area of the air guide may include an inclined surface that is disposed at a front section of the first area, where the inclined surface is inclined upward as the first area extends to a rear side of the first area.

In some examples, the air guide may further include a third area connected to a rear side of the second area, where the third area connects the second area and the heat exchanger and defines at least a portion of the interior space. A width of the introduction space in a leftward/rightward direction of the heat exchange device may be greater than a width of the third area in the leftward/rightward direction. In some examples, a height of the third area in the upward/downward direction of the heat exchange device may be greater than a height of each of the first area and the second area in the upward/downward direction.

In some implementations, the rotator may include a plurality of blade areas that are arranged about the rotation axis. In some examples, each of the plurality of blade areas has a front surface configured to be convex toward a rear side based on a corresponding one of the plurality of blade areas being located lower than the rotation axis.

In some implementations, the heat exchange device may further include a motor configured to provide power for rotating the rotator about the rotation axis.

In some examples, the first area, the second area, and the third area of the air guide are separately provided parts of the air guide, where the first area and the second area are fixedly coupled to each other, the second area and the third area are fixedly coupled to each other, and the third area and the heat exchanger are fixedly coupled to each other. In other examples, the first area, the second area, and the third area are provided integrally.

In some implementations, the rotator may include a plurality of blades that protrude outward from the rotation axis and extend along the rotation axis. In some examples, the plurality of blades may be orthogonal to one another.

According to another aspect, a vehicle includes the heat exchange device described above. The vehicle further includes an under-cover coupled to a lower area of the air guide, where the air guide further defines an introduction space that connects the outside of the air guide to the interior space, and the under-cover defines a through-hole at an area of the under-cover that faces the introduction space.

In some implementations, a lower end of the rotator may be located at a lower side of a lower surface of the under-cover. In some examples, at least a portion of the rotator may be configured to protrude downward relative to the under-cover based on rotating about the rotation axis.

### BRIEF DESCRIPTION OF THE DRAWINGS

The above and other objects, features and advantages of the present disclosure will be more apparent from the following detailed description taken in conjunction with the accompanying drawings.

FIG. 1 is a perspective view showing an example of a heat exchange device.

FIG. 2 is a side view of the heat exchange device.

FIG. 3 is an enlarged view showing a first area and a rotator of an air guide in the heat exchange device of FIG. 1.

FIG. 4 is a view illustrating an example of a flow path of air when a vehicle travels while the heat exchange device of FIG. 1 is mounted on the vehicle.

FIG. 5 is a side view showing an example of a heat exchange device.

### DETAILED DESCRIPTION

Hereinafter, a heat exchange device and a vehicle will be described with reference to the drawings.

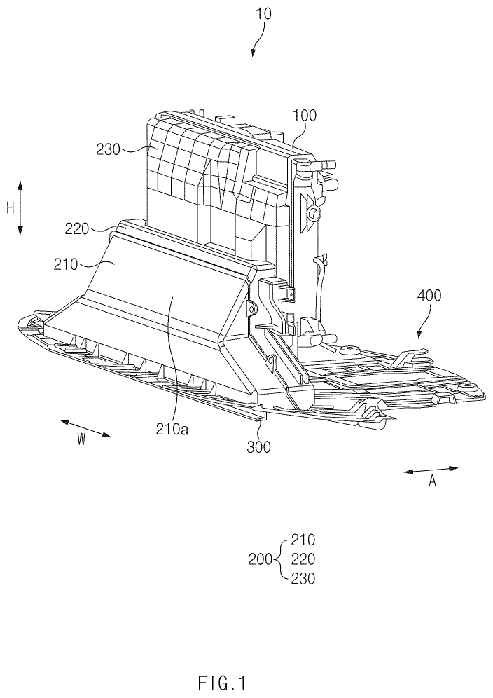

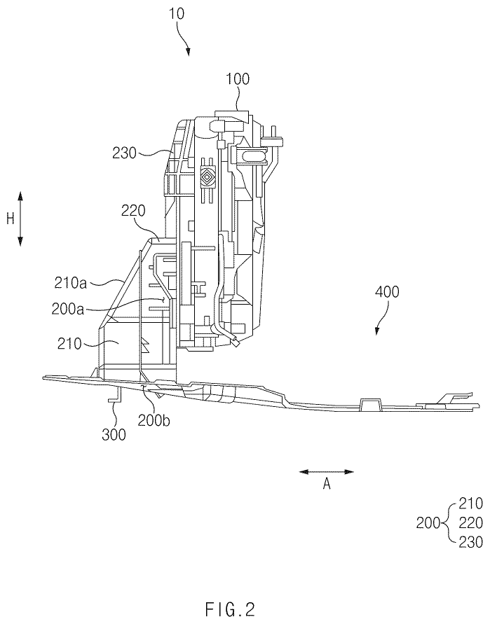

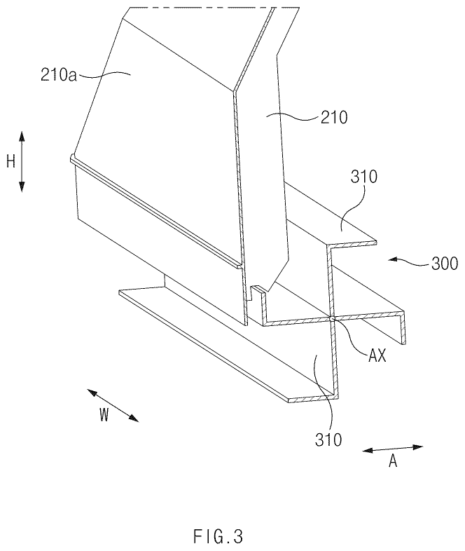

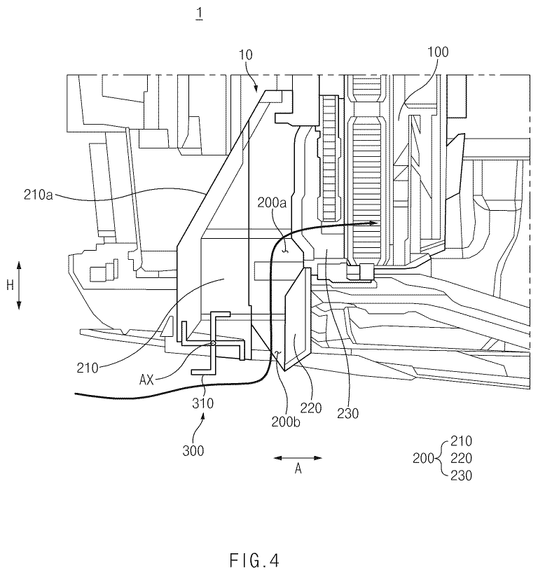

FIG. 1 is a perspective view showing an example of a heat exchange device, and FIG. 2 is a side view of the heat exchange device. FIG. 3 is an enlarged view showing an example of a first area and a rotator of an air guide in the heat exchange device of FIG. 1, and FIG. 4 is a view illustrating an example of a flow path of air when a vehicle travels while the heat exchange device of FIG. 1 is mounted on the vehicle.

In some implementations, a heat exchange device 10 may be a component for cooling a fluid (e.g., coolant, hereinafter referred to as “a heat exchange fluid”) that is introduced into the heat exchange device. For example, the heat exchange device 10 is a component that is mounted on a vehicle 1, and may be a component for cooling the heat exchange fluid that recovers heat that is generated from the parts in the vehicle 1.

In some example, the heat exchange device 10 may be an air-cooled heat exchange device 10 that cools the heat exchange fluid by receiving air from an outside and exchange heat between the air and the heat exchange fluid.

Referring to FIGS. 1 to 4, the heat exchange device 10 include a heat exchanger 100 that has a flow passage, through which the heat exchange fluid passes, and an air guide 200 that is provided on one side of the heat exchanger 100, and includes an interior space 200a, one side of which is communicated with the outside and an opposite side of which is communicated with the heat exchanger 100. The interior space 200a of the air guide 200 may define a flow passage, through which air supplied from the outside flows. That is, the air introduced into the interior space 200a of the air guide 200 from the outside may be introduced into the heat exchanger 100. It may be understood that the heat exchanger 100 is a component corresponding to a closed heat exchanger. In some implementations, as illustrated in FIGS. 1 to 4, the heat exchanger 100 may be fixedly coupled to a rear area of the air guide 200.

In some examples, an introduction space 200b that connects an outside of the air guide 200 and the interior space 200a may be formed in the air guide 200. That is, exterior air may be supplied to the interior space 200a through the introduction space 200b. Then, the introduction space 200b may be formed in a lower area of the air guide 200. Referring to FIGS. 1 to 4, it may be understood that the air guide 200 has a shape that is opened downward. Accordingly, in the heat exchange device 10, the air may be supplied to the interior space 200a of the air guide 200 through the lower area of the air guide 200.

In some examples, the heat exchange device 10 may further include a component that guides the exterior air to the interior space 200a so that the air may be smoothly supplied to the air guide 200 through the lower area of the air guide 200.

In more detail, as shown in FIGS. 1 to 4, the heat exchange device 10 may include a rotator 300 that is provided on one side of the air guide 200 and is rotatable about the rotation axis AX., as the rotator 300 is rotated about the rotation axis AX, the exterior air may be guided by the rotator 300 and may be introduced into the interior space 200a of the air guide 200.

In some examples, when the vehicle 1 travels with the heat exchange device 10 being mounted on the vehicle 1, the rotator 300 may be rotated about the rotation axis AX by driving wind caused by the air from a front side of the vehicle 1. For example, in an area, in which the left side corresponds to the front side with respect to FIG. 4, the rotator 300 may be rotated counterclockwise.

In some examples, rotation of the rotator 300 may in turn influence a flow direction of the air. That is, due to the rotation of rotator 300, the exterior air around the rotator 300 may flow in a direction that faces the air guide 200, that is, to be curved upward, and accordingly, the air may be effectively introduced into the interior space 200a of the air guide 200. Accordingly, even when the air guide 200 is opened downward, the exterior air may be effectively introduced into the interior space 200a.

In particular, because the exterior air may be smoothly supplied to the heat exchange device 10 without forming a separate hole for introducing the exterior air in a front component (for example, the bumper of the vehicle) of the vehicle 1, on which the heat exchange device 10 is mounted, a cooling performance of the vehicle 1 may be maintained or improved without harming the aesthetics of the vehicle 1.

In some examples, referring to FIGS. 1 to 4, in the heat exchange device 10, the rotator 300 may substantially have a propeller shape. In more detail, the rotator 300 may include a plurality of blade areas 310 (or blades 310) that are provided along a direction that crosses the rotation axis AX. In some examples, the rotation axis AX may extend in a leftward/rightward direction “W” of the vehicle 1. The plurality of blade areas 310 may be arranged about the rotation axis AX and extend along the rotation axis AX.

Furthermore, each of the blade areas 310 may have a geometric shape that allows the rotator 300 to be effectively rotated by the driving wind described above during a traveling process of the vehicle 1. In more detail, a blade area 310 may have a shape, a front surface of which is convex rearward when the blade area 310 is located in an area that is lower than the rotation axis AX. For example, FIGS. 1 to 4 illustrate that a blade area 310 includes a first section, a front surface of which is configured to have a shape that is convex rearward when the blade area 310 is located in an area that is than the rotation axis AX, and the blade area 310 extends in one direction from the rotation axis AX, and a second section that is bent in another direction from the first section. In this case, it may be understood that the blade area 310 may have a substantially L-shaped cross-sectional shape. In some implementations, the blade area 310 may have a curved cross-sectional shape. In some examples, the plurality of blades 310 may protrude outward from the rotation axis AX and extend along the rotation axis AX. In some examples, the plurality of blades 310 may be orthogonal to one another.

In some examples, the exterior air may be guided more effectively to the interior space 200a in a process of rotating the rotator 300 that is rotated by the driving wind that is generated in the traveling process of the vehicle 1. For example, the rotator 300 may be configured such that (i) at least a portion thereof is disposed on the introduction space 200b, or (ii) at least a portion thereof faces the introduction space 200b in a forward/rearward direction “A.” As an example, FIG. 4 illustrates that the rotator 300 faces a rear area of the introduction space 200b in the forward/rearward direction “A” by disposing a portion of the rotator 300 in a front area of the introduction space 200b. It may be understood that at least a portion of the introduction space 200b is formed on a rear side of the rotator 300 as the rotator 300 is declined to the front area of the introduction space 200b. This may be to ensure that the exterior air guided by the rotation of the rotator 300 is smoothly supplied to the interior space 200a through the introduction space 200b.

In some examples, referring now to FIG. 4, the interior space 200a may be formed at at least a portion of the air guide 200, which faces the rotator 300 in the upward/downward direction “H.” In this case, because an amount of the air that may be introduced into the air guide 200 may be maximized, an amount of the air supplied to the heat exchanger 100 may be increased.

In some implementations, unlike the illustration of FIG. 4, at least a portion of an area of the air guide 200, which faces the rotator 300 in the upward/downward direction “H,” may be spaced apart from the interior space 200a described above. This may be understood that at least a portion of the area located on the upper side of the rotator 300 in the air guide 200 do not contribute to forming the interior space 200a. As described above, the heat exchanger 100 may be fixedly coupled to the rear area of the air guide 200. In this case, because the upper area of the air guide 200 may be spaced forward from the path, through which the exterior air flows until the exterior air guided by the rotation of the rotator 300 is supplied to the heat exchanger 100, forming a space, in which the exterior air is stored, in the upper area of the air guide 200 may not be of great benefit. Accordingly, when the interior space 200a is not formed at at least a portion of an area of the air guide 200, which is located on an upper side of the rotator 300, the flow path until the exterior air is supplied to the heat exchanger 100 may be made simpler.

In some examples, the air guide 200 may be divided into a plurality of areas. For example, the air guide 200 may include a first area 210 that defines the front area of the air guide 200) and is configured such that at least a portion thereof faces the rotator 300 in the upward/downward direction “H,” a second area 220 that is connected to a rear side of the first area 210, and in which at least a portion of the interior space 200a is formed, and a third area 230 that is connected to a rear side of the second area 220, connects the second area 220 and the heat exchanger 100, and defines at least a part of the interior space 200a.

In some implementations, the first area 210, the second area 220, and the third area 230 described above may be provided separately, the first area 210 and the second area 220 may be fixedly coupled to each other, the second area 220 and the third area 230 may be fixedly coupled to each other, and the third area 230 and the heat exchanger 100 may be fixedly coupled to each other. In other implementations, the first area 210, the second area 220, and the third area 230 may be formed integrally with each other.

Referring to FIGS. 1 to 4, the rotator 300 and the second area 220 may be configured to be spaced apart from each other in the forward/rearward direction “A,” and the lower end of the second area 220 may be located on a lower side of the lower end of the first area 210. The lower end of the second area 220 is located on a lower side of the lower end of the first area 210, such that the amount of the exterior air guided by the rotator of the rotator 300, which is introduced into the interior space 200a, may be maximized.

In some implementations, the front section of the first area 210 may include an inclined surface 210a that is located on an upper side as it goes toward the rear side. The inclined surface 210a may be a component that defines a front end of the interior space 200a so that air introduced into the interior space 200a may be smoothly supplied to the heat exchanger 100.

In some examples, the introduction space 200b may be formed in a lower area than the first area 210 and the second area 220. Then, a width of the introduction space 200b in the leftward/rightward direction “W” may be greater than a width of the third area 230 in the leftward/rightward direction “W.” This may be to maximize an amount of the exterior air guided by the rotation of the rotator 300, which is introduced into the interior space 200a, by maximizing a size of the introduction space 200b.

In some examples, the air guide 200 may have an overall shape in which a height of the air guide 200 in the upward/downward direction “H” increases as it extends toward the rear side, that is, as it becomes closer the heat exchanger 100. For example, referring to the drawing, a height of the third area 230 in the upward/downward direction “H” is greater than heights of the first area 210 and the second area 220 in the upward/downward direction “H.” In some examples, the height of the third area 230 in the upward/downward direction “H” and the width in the leftward/rightward direction “W” may correspond to the height of the heat exchanger 100 in the upward/downward direction “H” and the width of in the leftward/rightward direction “W,” respectively. In this case, the exterior air flowing into the interior space 200a may be uniformly supplied to the heat exchanger 100.

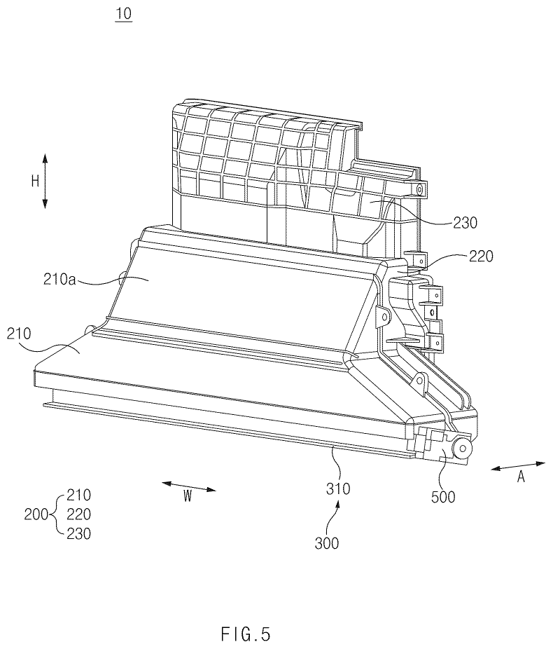

FIG. 5 is a side view showing an example of a heat exchange device.

Compared to the heat exchange device 10 described above with reference to FIGS. 1 to 4, the heat exchange device 10 illustrated in FIG. 5 is different in that it further includes a rotational power part 500 that provides power for rotating the rotator 300 about the rotation axis AX. That is, the implementation shown in FIG. 5 is different from the heat exchange device described above in that the rotator 300 may be rotated through a separate power source regardless of the driving wind that is generated the traveling process of the vehicle 1. In this case, because a rotational speed of the rotator 300 may be actively controlled in the traveling process of the vehicle 1, the amount of the air introduced into the interior space 200a by the rotation of the rotator 300 may be actively adjusted. For example, a rotational power part 500 may be an electric motor. The contents of the heat exchange device 10 except for the rotational power part 500 will be replaced with the description of the heat exchange device 10 described above, which has been made with reference to FIGS. 1 to 4.

In some implementations, the vehicle 1 may include the heat exchange device 10, and an under-cover 400 that is coupled to the lower area of the air guide 200 provided in the heat exchange device 10 and substantially has a plate shape. The under-cover 400 may be a component that defines a lower surface of the vehicle 1. As illustrated in FIG. 4, the under-cover 400 may be fixedly coupled to the lower areas of the first area 210 and the second area 220, and may be spaced apart from the third area 230 in the upward/downward direction “H.”

In some examples, a through-hole may be formed at at least a portion of the area of the under-cover, which faces the introduction space 200b. The through-hole formed in the under-cover 400 may serve as a path so that the exterior air guided by the rotator 300 may be introduced into the interior space 200a through the introduction space 200b.

Furthermore, in the vehicle 1 of the present disclosure, the lower end of the rotator 300 may be located on a lower side of the lower surface of the under-cover 400. In this case, the rotator 300 may more effectively guide the exterior air that flows in the lower area of the under-cover 400. In some examples, the contents of the heat exchange device 10 of the vehicle 1 is replaced with the above-described contents of the heat exchange device 10.

According to the present disclosure, the aesthetics and aerodynamic performance of a vehicle may be improved by allowing parts in the vehicle to be effectively cooled even while holes formed in a front area of the vehicle is eliminated.

Although the present disclosure has been described with reference to the implementations, it will be appreciated by an ordinary skilled in the art, to which the present disclosure pertains, that the present disclosure may be modified and changed within the scope of the appended claims without departing from the spirits and technical field of the present disclosure.

What is claimed is:

1. A heat exchange device comprising:
a heat exchanger that defines a flow passage configured to carry a heat exchange fluid;
an air guide that is disposed at a side of the heat exchanger and defines an interior space, the air guide having (i) a first side in fluid communication with an outside of the air guide and (ii) a second side in fluid communication with the heat exchanger; and
a rotator disposed at the first side of the air guide and configured to rotate about a rotation axis.

2. The heat exchange device of claim 1, wherein the air guide further defines an introduction space that connects the outside of the air guide to the interior space, the introduction space being defined at a lower area of the air guide.

3. The heat exchange device of claim 2, wherein at least a portion of the rotator is disposed in the introduction space or faces the introduction space in a forward/rearward direction of the heat exchange device.

4. The heat exchange device of claim 3, wherein at least a portion of the introduction space is defined at a rear side of the rotator.

5. The heat exchange device of claim 3, wherein the interior space is defined at an area of the air guide, the area of the air guide facing the rotator in an upward/downward direction of the heat exchange device.

6. The heat exchange device of claim 3, wherein the air guide has an area that faces the rotator in an upward/downward direction of the heat exchange device and is spaced apart from the interior space.

7. The heat exchange device of claim 2, wherein the air guide includes:
a first area, wherein at least a portion of the first area faces the rotator in an upward/downward direction of the heat exchange device; and
a second area that is connected to a rear side of the first area and defines at least a portion of the interior space,
wherein the rotator and the second area of the air guide are spaced apart from each other in a forward/rearward direction of the heat exchange device, and
wherein a lower end of the second area is located at a lower end of the first area.

8. The heat exchange device of claim 7, wherein the first area of the air guide includes an inclined surface that is disposed at a front section of the first area, the inclined surface being inclined upward as the first area extends to a rear side of the first area.

9. The heat exchange device of claim 7, wherein the air guide further includes:
a third area connected to a rear side of the second area, the third area connecting the second area and the heat exchanger and defining at least a portion of the interior space, and
wherein a width of the introduction space in a leftward/rightward direction of the heat exchange device is greater than a width of the third area in the leftward/rightward direction.

10. The heat exchange device of claim 9, wherein a height of the third area in the upward/downward direction of the heat exchange device is greater than a height of each of the first area and the second area in the upward/downward direction.

11. The heat exchange device of claim 1, wherein the rotator comprises a plurality of blades that are arranged about the rotation axis.

12. The heat exchange device of claim 11, wherein each of the plurality of blades has a front surface configured to be convex toward a rear side based on a corresponding one of the plurality of blades being located lower than the rotation axis.

13. The heat exchange device of claim 1, further comprising:
a motor configured to provide power for rotating the rotator about the rotation axis.

14. The heat exchange device of claim 9, wherein the first area, the second area, and the third area are separately provided parts of the air guide,
wherein the first area and the second area are fixedly coupled to each other,
wherein the second area and the third area are fixedly coupled to each other, and
wherein the third area and the heat exchanger are fixedly coupled to each other.

15. The heat exchange device of claim 9, wherein the first area, the second area, and the third area are provided integrally.

16. The heat exchange device of claim 11, wherein the plurality of blades protrude outward from the rotation axis and extend along the rotation axis.

17. The heat exchange device of claim 16, wherein the plurality of blades are orthogonal to one another.

18. A vehicle comprising:
the heat exchange device of claim 1; and
an under-cover coupled to a lower area of the air guide,
wherein the air guide further defines an introduction space that connects the outside of the air guide to the interior space, and
wherein the under-cover defines a through-hole at an area of the under-cover that faces the introduction space.

19. The vehicle of claim 18, wherein a lower end of the rotator is located at a lower side of a lower surface of the under-cover.

20. The vehicle of claim 18, wherein at least a portion of the rotator is configured to protrude downward relative to the under-cover based on rotating about the rotation axis.
